(19) United States
(12) Patent Application Publication
(10) Pub. No.: US 2006/0103602 A1
(43) Pub. Date: May 18, 2006

(54) Plasma display device and driving method thereof

(75) Inventor: Joon-Yeon Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/272,812

(22) Filed: Nov. 15, 2005

(30) Foreign Application Priority Data
Nov. 16, 2004 (KR) 10-2004-0093431

(51) Int. Cl. G09G 3/28

(52) U.S. Cl. 345/67

(57) ABSTRACT

In a plasma display device, an M electrode is provided between the X and Y electrodes. When an X or Y electrode driver applies a sustain pulse voltage of Vs/2 during a sustain period, a third power source also applies voltage Vs/2 to a node of the M electrode driver. The node of the M electrode driver is alternately connected to the drivers for the X and Y electrodes, thus increasing the total sustain pulse voltage differences between those electrodes to Vs. Therefore, the voltage of the power sources used to apply the sustain pulses can be reduced. Additionally, the M electrode applies the reset waveforms in the reset period, allowing the X and Y electrode driver circuits to be nearly identical. Therefore, a uniform sustain waveform is applied, and poor discharge in the sustain period is reduced.

### CROSS REFERENCE TO RELATED APPLICATION

This application claims priority to and the benefit of Korean Patent Application No. 10-2004-0093431, filed on Nov. 16, 2004, which is hereby incorporated by reference for all purposes as if fully set forth herein.

### BACKGROUND OF THE INVENTION

1. Field of the Invention

The present invention relates to a plasma display device and a driving method thereof.

2. Discussion of the Background

Recently, flat panel displays such as liquid crystal display devices (LCDs), field emission displays (FEDs), and plasma display devices have been actively developed. The plasma display devices of the flat panel displays have better brightness and luminescence efficiency, and wider viewing angles compared to other types of flat panel displays. Therefore, the plasma displays have developed as substitutes for the conventional cathode ray tubes (CRTs) in displays measuring greater than 40 inches.

The plasma display device is a flat panel display for displaying characters or images by using plasma generated by gas discharge, and it can have from several scores to several millions of pixels arranged in a matrix format thereon. The plasma display device can be classified as a DC plasma display device or an AC plasma display device depending on the format of applied driving voltage waveforms and configurations of discharge cells.

A DC plasma display device has electrodes exposed to a discharge space without insulation, thereby causing a current to directly flow to the discharge space during application of a voltage to the DC plasma display device. Therefore, a DC PDP requires a resistance for limiting the current. Conversely, an AC plasma display device has electrodes covered with a dielectric layer that forms a natural capacitance to restrict the current and protects the electrodes from the impact of ions during discharge. Therefore, the AC plasma display device is superior to the DC plasma display device with regard to lifetime.

FIG. 1 shows a partial perspective view of a conventional AC PDP, and FIG. 2 shows a cross-sectional view of the PDP shown in FIG. 1.

As shown in FIGS. 1 and 2, X electrodes 3 and Y electrodes 4, made of transparent conductive matter and disposed over a dielectric layer 14 and a protection film 15, are provided in parallel and form pairs with each other under a first glass substrate 11. Metallic bus electrodes 6 are respectively formed on the surfaces of both the X and Y electrodes 3 and 4.

A plurality of address electrodes 5 covered with a dielectric layer 14′ are installed on a second glass substrate 12. Barrier ribs 17 are formed in parallel with the address electrodes 5, on the dielectric layer 14′ and between the address electrodes 5. In addition, a plurality of phosphors 18 are formed on the surface of the dielectric layer 14′ between the barrier ribs 17. The first and second glass substrates 11 and 12, having a discharge space between them, face each other so that the Y electrodes 4 and the X electrodes 3 may intersect the address electrodes 5. An address electrode 5 and a discharge space formed between the intersection of a Y electrode 4 and an address electrode 5 and the intersection of an X electrode 3 and an address electrode 5 form a discharge cell 19.

FIG. 3 shows a conventional PDP electrode arrangement diagram.

As shown, the conventional PDP electrode has an m×n matrix configuration of address electrodes A1 to Am in the column direction, and Y electrodes Y1 to Yn alternating with X electrodes X1 to Xn in the row direction. The discharge cell 20 shown in FIG. 3 corresponds to the discharge cell 19 shown in FIG. 1.

FIG. 4 shows a conventional PDP driving waveform diagram.

Each subfield according to the conventional PDP method shown in FIG. 4 includes a reset period, an address period, and a sustain period.

The reset period erases wall charge states of a previous sustain, and sets up the wall charges in order to stably perform a next address.

The address period is for selecting cells to be turned on and turned off during the sustain period, termed turn-on and turn-off cells respectively. Additionally, during the address period, wall charges accumulate in the turn-on cells, also referred to as addressed cells.

In the sustain period, discharge for actually emitting light from the addressed cells is performed by alternately applying a sustain discharge voltage to the X and Y electrodes.

Operations of the conventional reset period of the conventional PDP driving method will now be described in detail. As shown in FIG. 4, the reset period includes an erase period, a Y ramp rising period, and a Y ramp falling period.

Erase period (I): While an X electrode is biased with a constant potential of Vbias, a falling ramp which slowly falls from a sustain discharge voltage of Vs to a ground potential is applied to a Y electrode, and the wall charges formed in the sustain period are eliminated.

Y ramp rising period (II): During this period, the address electrode and the X electrode are maintained at 0V, and a ramp voltage, gradually rising from the voltage of Vs to the voltage of Vset, is applied to the Y electrode. While the ramp voltage rises, a weak reset discharge is generated in all the discharge cells from the Y electrode to the address electrode and the X electrode. As a result, the negative (−) wall charges are accumulated to the Y electrode, and concurrently, the positive (+) wall charges are accumulated to the address electrode and the X electrode.

Y ramp falling period (III): In the latter part of the reset period, a ramp voltage that gradually falls from the voltage of Vs to 0V is applied to the Y electrode while the X electrode maintains the constant voltage of Vbias. While the ramp voltage falls, a weak reset discharge is generated again in all the discharge cells.

However, a poor discharge may result since insufficient priming particles may be generated in the discharge cell when the first sustain pulse is applied after the address period in the conventional PDP.

In the sustain period, the sustain discharge voltage Vs is alternately applied to the X electrode and the Y electrode to perform a sustain discharge for displaying images on the is addressed cells. To achieve good discharge during the sustain period, a symmetric waveform should be applied to the X electrode and the Y electrode in the sustain period. However, a circuit for driving the Y electrode and a circuit for driving the X electrode are different in the conventional plasma display device because the waveform applied to the Y electrode includes an additional waveform for resetting and scanning, unlike the X electrode waveform. Accordingly, the impedances of the driving circuits of the X electrode and the Y electrode are unequal, and hence, the waveform alternately applied to the X electrode and the Y electrode in the sustain period is distorted and may generate a poor discharge.

The above information disclosed in this Background section is only for enhancement of understanding of the background of the invention and therefore it may contain information that does not form the prior art that is already known in this country to a person of ordinary skill in the art.

### SUMMARY OF THE INVENTION

This invention provides a plasma display device and a driving method thereof that prevents poor sustain discharges between the X and Y electrodes.

The present invention also provides a plasma display device and a driving method thereof that reduces the production cost of the circuit for applying waveforms in the sustain period.

Additional features of the invention will be set forth in the description which follows, and in part will be apparent from the description, or may be learned by practice of the invention.

The present invention discloses a plasma display device with a plasma display panel comprised of a first driving circuit, a second driving circuit, and a third driving circuit. The plasma display panel also comprises a plurality of first electrodes, second electrodes, and third electrodes in parallel with the first electrodes and the second electrodes. The first driving circuit, the second driving circuit, and the third driving circuit drive the first electrodes, the second electrodes, and the third electrodes respectively.

The first driving circuit comprises two switches: the first switch is coupled to an output terminal of a first power source for supplying a voltage to the first electrodes in a sustain period, and is coupled between a first terminal of a first capacitor charged with a first voltage and the first electrode. The second switch is coupled between a second power source for supplying a second voltage that is less than the first voltage to the first electrode in the sustain period and the first electrode.

The third driving circuit comprises a third switch, a fourth switch, a fifth switch, and a sixth switch. The third switch has a first terminal coupled to the third electrode. The fourth switch is coupled between a third power source for supplying a third voltage that is greater than the second voltage to a second terminal of the third switch in the sustain period and the second terminal of the third switch. The fifth switch is coupled between a fourth power source for supplying a fourth voltage that is less than the first voltage to the second terminal of the third switch in the sustain period and the second terminal of the third switch. The sixth switch is coupled between the second terminal of the third switch and the second terminal of the first capacitor, and supplies an output of the second terminal of the third switch to the second terminal of the first capacitor in the sustain period.

The present invention also discloses a method for driving a plasma display device where the plasma display device comprises a plurality of first electrodes, second electrodes, and third electrodes, where the third electrodes are parallel to the first and second electrodes. The is plasma display device also comprises a first driving circuit, a second driving circuit, and a third driving circuit for respectively driving the first electrodes, the second electrodes, and the third electrodes.

The first driving circuit comprises a first switch coupled to an output terminal of a first power source for supplying a voltage to the first electrodes, and the first switch is also coupled between a first terminal of a first capacitor charged with a first voltage and the first electrode. The third driving circuit comprises a second switch with a first terminal coupled to the third electrode and that performs a switching operation for applying a scan pulse voltage to the third electrode in an address period. The plasma display device also includes a third switch coupled between a second terminal of the first capacitor and a second terminal of the second switch.

In a sustain period, a voltage at the first electrode is increased to the first voltage by using the first driving circuit; a voltage at the second terminal of the second switch is increased to a second voltage by using the third driving circuit, and the voltage at the first electrode is increased to the third voltage from the first voltage by turning on the third switch; the voltage at the first electrode is maintained at the third voltage; a voltage at the second terminal of the second switch is decreased to a fourth voltage that is less than the second voltage by using the third driving circuit, and a voltage at the first electrode is decreased to the first voltage from the third voltage by turning on the third switch; and the voltage at the first electrode is decreased to a fifth voltage that is less than the first voltage by using the first driving circuit.

The present invention also discloses a method for driving a plasma display device comprising a first driving circuit for supplying a first sustain voltage to a plurality of first electrodes, where the first driving circuit comprises a first capacitor charged with a first voltage, and a first switch coupled between a first terminal of the first capacitor and the first electrodes. In a sustain period, the voltage at the first electrodes is increased to the first voltage by using the first driving circuit during a first period; a voltage at a second terminal of the first capacitor is increased by using a first power source unit, and the voltage at the first electrodes is increased to the first sustain voltage during a second period; the voltage at the first electrodes is maintained to be the first sustain voltage during a third period; the voltage at the second terminal of the first capacitor is decreased by using the first power source unit, and the voltage at the first electrodes is decreased to the first voltage during a fourth period; and the voltage at the first electrodes is decreased to a second voltage that is less than the first voltage by using the first driving circuit during a fifth period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a perspective view of a conventional PDP.

FIG. 2 shows a cross-sectional view of the PDP shown in FIG. 1.

FIG. 3 shows a conventional electrode arrangement diagram of the plasma display device.

FIG. 4 shows a conventional driving waveform diagram of the plasma display device.

FIG. 5 shows an electrode arrangement diagram of a PDP according to a first exemplary embodiment of the present invention.

FIG. 6 and FIG. 7 respectively show a perspective view and a cross-sectional view of a PDP according to a first exemplary embodiment of the present invention.

FIG. 8 shows a driving waveform diagram of a PDP according to a first exemplary embodiment of the present invention.

FIGS. 9A to 9E show wall charge distribution diagrams based on a driving waveform according to a first exemplary embodiment of the present invention.

FIG. 10 shows a plasma display device according to a second exemplary embodiment of the present invention.

FIG. 11 shows a waveform applied in the sustain period and a switching operation in a driving waveform of a plasma display device according to a second exemplary embodiment of the present invention.

FIG. 12 shows a driving circuit of a Y electrode driver for generating a driving waveform in the sustain period according to a second exemplary embodiment of the present invention.

FIG. 13 shows a driving circuit of an X electrode driver in the sustain period according to a second exemplary embodiment of the present invention.

FIG. 14 shows a driving circuit of an M electrode driver for generating a driving waveform in the sustain period according to a second exemplary embodiment of the present invention.

FIG. 15A shows a circuit for coupling a driving circuit of an M electrode driver and a driving circuit of a Y electrode driver, and FIG. 15B shows a circuit for coupling a driving circuit of an M electrode driver and a driving circuit of an X electrode driver.

FIGS. 16A to 16D show current paths for generating the driving waveforms shown in FIG. 11 in the driving circuit of the M electrode driver.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

Like reference numerals designate like elements throughout the specification. In addition, wall charges represent charges formed and accumulated on a wall (e.g., a dielectric layer) close to an electrode of a discharge cell. Further, although the wall charges do not actually touch the electrodes, the wall charges will be described as being “formed” or “accumulated” on the electrode. A wall voltage indicates a potential difference generated on the wall of a discharge cell according to wall charges.

A plasma display device and a driving method thereof according to an exemplary embodiment of the present invention will now be described in detail with reference to drawings.

FIG. 5 shows an electrode arrangement diagram of a PDP according to an exemplary embodiment of the present invention.

As shown in FIG. 5, the PDP includes address electrodes A1 to Am arranged in is parallel in the column direction, Y electrodes Y1 to Yn in n rows, X electrodes X1 to Xn in n rows, and middle electrodes (hereinafter referred to as M electrodes) in n rows. That is, the M electrodes are arranged between the Y and X electrodes, and a Y electrode, an X electrode, an M electrode, and an address electrode form a single discharge cell 30.

The X and Y electrodes function as electrodes for applying sustain discharge voltage waveforms, and the M electrodes function as electrodes for applying a reset waveform and a scan pulse voltage.

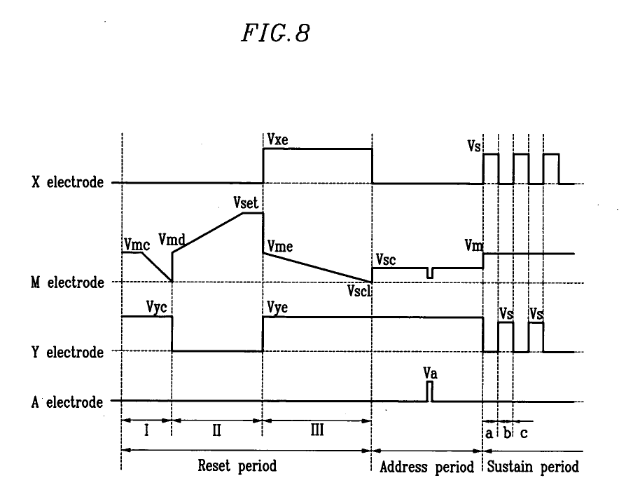

FIG. 6 and FIG. 7 respectively show a perspective view and a cross-sectional view of a PDP according to an exemplary embodiment of the present invention.

Referring to FIG. 6 and FIG. 7, the PDP includes a first substrate 41 and a second substrate 42. An X electrode 53 and a Y electrode 54 are formed on the first substrate 41. A bus electrode 46 is formed on the X electrode 53 and Y electrode 54. A dielectric layer 44 and a protective layer 45 are sequentially formed on the X and Y electrodes 53 and 54.

An address electrode 55 is formed on the surface of the second substrate 42, and a dielectric layer 44′ is formed on the address electrode 55. The barrier ribs 47 are formed parallel to address electrodes 55 on the dielectric layer 44′. A phosphor 48 is coated on the surface of the barrier ribs 47 in the cell space between the barrier ribs 47. The X and Y electrodes 53 and 54 are formed to cross the address electrode 55. A discharge cell 49 is formed between barrier ribs 47.

A middle electrode 56 is formed between the X and Y electrodes 53 and 54 formed in a pair on the surface of the first substrate 41. As described above, a reset waveform and a scan waveform are mainly applied to the middle electrode. A bus electrode 46 is formed on the middle electrode 56.

The driving method of the plasma display device to be described has a reset period, an address period, and a sustain period.

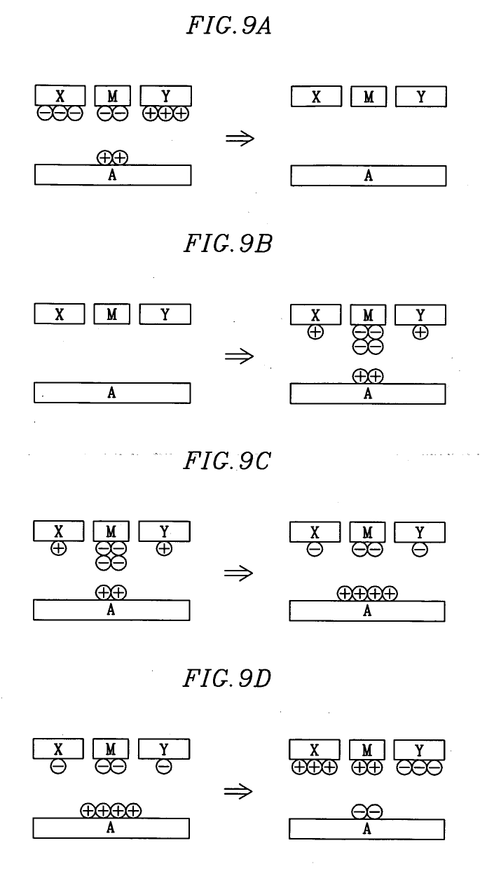

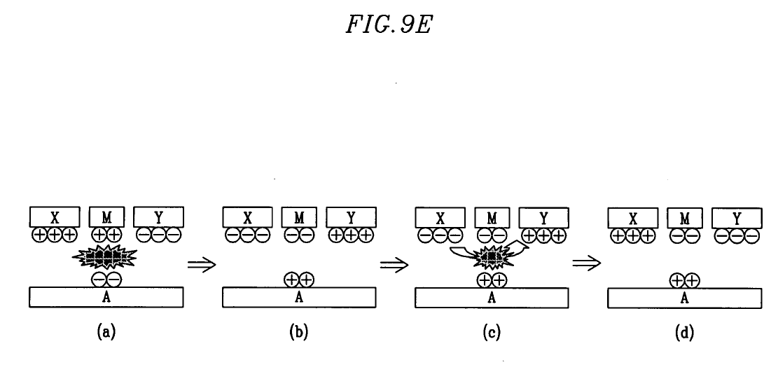

FIG. 8 shows a driving waveform diagram of a PDP according to a first exemplary embodiment of the present invention, and FIG. 9A to FIG. 9E show wall charge distribution diagrams based on the driving waveform of FIG. 8.

Referring to FIG. 8 and FIG. 9A to FIG. 9E, the driving method according to the first exemplary embodiment of the present invention will now be described.

Each subfield includes a reset period, an address period, and a sustain period according to the driving method shown in FIG. 8 according to the exemplary embodiment.

The reset period includes an erase period, an M electrode rising waveform period, and an M electrode falling waveform period.

Erase period (I): In the erase period, the wall charges formed during a previous sustain period are erased. Assuming that a sustain discharge voltage pulse is applied to the X electrode and a voltage (e.g., a ground voltage) which is lower than the voltage applied to the X electrode is applied to the Y electrode at the last point of the sustain period, (+) wall charges are formed on the Y electrode and the address electrode and (−) wall charges are formed on the X electrode and the M electrode, as shown in FIG. 9A.

In the erase period, a waveform (a ramp waveform or a logarithmic waveform) which gradually decreases to the ground voltage from the voltage of Vmc is applied to the M electrode while the Y electrode is biased with the voltage of Vyc. Accordingly, the wall charges formed during the sustain period are erased as shown in FIG. 9A.

M electrode rising waveform period (II): In this period, a waveform (a ramp waveform or a logarithmic waveform) which gradually increases to the voltage of Vset from the voltage of Vmd is applied to the M electrode while the X and Y electrodes are biased with the ground voltage. Vset exceeds the discharge firing voltage Vf and a weak reset discharge is generated at all the discharge cells from the M electrode to the address electrode, the X electrode, and the Y electrode. As a result, the negative (−) wall charges are accumulated on the M electrode, and the positive (+) wall charges are accumulated on the address electrode, the X electrode, and the Y electrode as shown in FIG. 9B.

M electrode falling waveform period (III): In the latter part of the reset period, the M electrode is applied with a waveform that gradually drops from voltage Vme to Vscl. Vscl may be set to ground voltage. The waveform applied to M electrode may be a ramp or logarithmic waveform. Concurrently while the M electrode's voltage is dropping, the X and Y electrodes are biased with the voltages of Ve and Vye, respectively. Voltages may be set so that Vxe=Vye and Vmd=Vme.

Weak reset discharges are generated at discharge cells again while the ramp voltage falls. Because wall charges reduce during the M electrode falling waveform period, an increase in the duration of the falling waveform results in more precise control over the reduction of the wall charges.

When the falling waveform is applied to the M electrode, the wall charges accumulated on the respective electrode of all the cells are equivalently erased, the (+) wall charges are stored on the address electrode, and the (−) wall charges are concurrently stored on the X electrode, the Y electrode, and the M electrode, as shown in FIG. 9C.

Address period (Scan period): In the address period, while the M electrodes are biased with the voltage of Vsch, a scan pulse with magnitude equal to Vscl or the ground voltage is sequentially applied to the M electrodes, and an address voltage is applied to the address electrodes corresponding to the cells to be discharged (i.e., turned-on cells). In this instance, the X electrode is maintained at the ground voltage, and a positive voltage Vye is applied to the Y electrode.

A discharge is generated between the M electrode and the address electrode, a discharge is generated between the X electrode and the Y electrode, and as shown in FIG. 9D, the (+) charges are stored at the X and M electrodes and the (−) wall charges are stored at the Y electrode and the address electrode.

Sustain period: In the sustain period, a sustain discharge voltage pulse is alternately applied to the X and Y electrodes while the M electrode is biased with the sustain discharge voltage of Vm. A sustain discharge is generated at the discharge cells selected in the address period through applying the voltage. In this instance, the number of power sources may be reduced by selecting the voltage Vm applied to the M electrode to correspond to voltage Vs.

In this instance, discharges are generated through different discharge mechanisms in the initial sustain discharge stage and the normal stage. For ease of description, the discharge which occurs at the initial part of the sustain discharge will be referred to as a short-gap discharge period, and the discharges after the initial portion of the sustain period will be referred to as a long-gap discharge period.

Short-gap discharge period: As shown in (a) and (b) of FIG. 9E, (+) voltage pulses are applied to the X electrode and (−) voltage pulses are applied to the Y electrode in the start period of the sustain discharge. Here the signs of (+) and (−) represent relative charges based upon the relative magnitude of the voltage applied to the X electrode versus the magnitude of the voltage applied to the Y electrode. Applying the (+) pulse voltages to the X electrode represents applying a voltage which is greater than the voltage applied to the Y electrode to the X electrode. Concurrently, the (+) voltage pulses are applied to the M electrode. Therefore, the discharges between the X electrode and the M electrode, or between the X electrode and the Y electrode are generated, differing from the conventional discharge generated between only the X and Y electrodes. In particular, the electrical field applied between the M and Y electrodes is increases since the distance between the M and Y electrodes is shorter than the distance between the X and Y electrodes. Therefore, the discharge between the M and Y electrodes performs a more dominant role than the discharge between the X and Y electrodes. Accordingly, the discharge which occurs at the initial part of the sustain discharge is called the short-gap discharge, where the discharge between the M and Y electrodes plays a substantial role.

Since the relatively higher electric field is applied at the earlier stage of the sustain discharge to generate a short gap discharge, a sufficient discharge results even if insufficient priming particles are generated in the discharge cell at the time of applying a first sustain pulse after the address period. As a result, poor discharges are avoided where insufficient charges are present.

3-2

Long-gap discharge period: Since the voltage at the M electrode is biased with a constant voltage of Vm after the first sustain pulse of the sustain discharge is applied, the discharge between the M and X electrodes or the discharge between the M and Y electrodes contributes less to the discharge. The discharge between the X and Y electrodes becomes the main discharge, and as a result, the input video is displayed according to the number of discharge pulses alternately applied to the X and Y electrodes.

During the discharge between the X and Y electrodes, as shown in (d) of FIG. 9E, the (−) wall charges are stored on the M electrode, and the (−) and (+) wall charges are alternately stored on the X and Y electrodes during the sustain period in the normal state.

According to the exemplary embodiment, a sufficient discharge results even when fewer priming particles are provided since the discharge is initially performed by the short gap discharge between the X and M electrodes, or between the Y and M electrodes, in the initial part of the sustain discharge, and a stable discharge is performed in the normal state since the discharge is performed according to the long gap discharge between the X and Y electrodes.

Also, since almost symmetric voltage waveforms are applied to the X and Y electrodes, the circuits for driving the X and Y electrodes are nearly identical. Therefore, since most of the difference of the circuit impedance between the X and Y electrodes is eliminated, distortion of the pulse waveforms applied to the X and Y electrodes is reduced to further support stable discharge during the sustain period.

According to the first embodiment shown in FIG. 8, the PDP can be driven when the waveforms of the X and Y electrodes are exchanged, and also when the waveforms of the X and Y electrodes are exchanged in the address period.

Hence, the reset waveform and the scan pulse waveform are mainly applied to the M electrode, and the sustain voltage waveform is mainly applied to the X and Y electrodes. However, other types of reset waveforms can also be applied to the M electrode in addition to the reset waveform shown in FIG. 8.

In the sustain period according to the driving method of the first embodiment, the sustain pulse voltage of Vs is applied to the X electrode or the Y electrode while the M electrode is biased with the voltage of Vm. Hence, a power recovery circuit for recovering reactive power by using LC resonance of a panel capacitor and an inductor formed between an X electrode, a Y electrode, an M electrode, and an A electrode may be used to apply the sustain pulse of Vs to the X electrode or the Y electrode. When the power recovery circuit is used, a power source for providing the voltage of Vs is generally used. A method for providing the sustain pulse voltage of Vs through a power source that supplies a voltage less than the voltage of Vs will now be described.

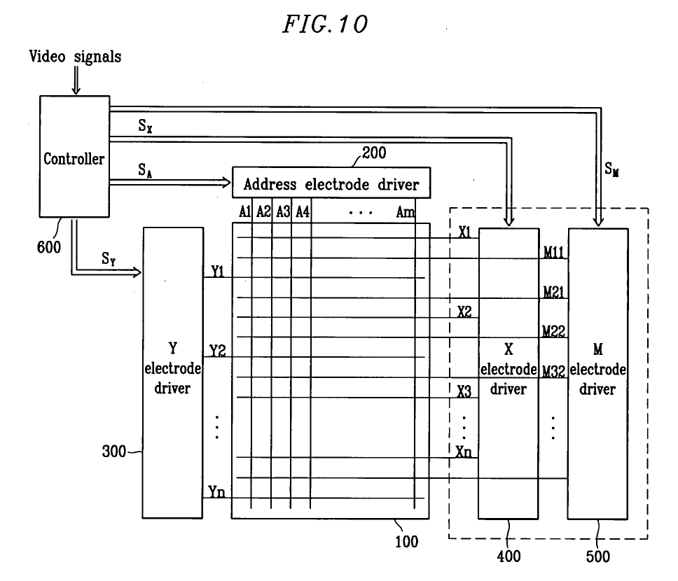

FIG. 10 shows a plasma display device according to an exemplary embodiment of the present invention.

As shown, the plasma display comprises a plasma display panel 100, an address electrode driver 200, a Y electrode driver 300, an X electrode driver 400, an M electrode driver 500, and a controller 600.

The PDP 100 comprises a plurality of address electrodes A1 to Am arranged in the column direction, and a plurality of Y electrodes Y1 to Yn, X electrodes X1 to Xn, and Mij electrodes arranged in the row direction. The Mij electrodes represent electrodes formed between the Yi electrodes and the Xj electrodes.

The controller 600 receives external video signals, generates an address driving control signal S_{A}, a Y electrode driving signal S_{Y}, an X electrode driving signal S_{X}, and an M electrode driving signal S_{M}, and transmits them to the address driver 200, the Y electrode driver 300, the X electrode driver 400, and the M electrode driver 500, respectively.

The address driver 200 receives an address driving control signal S_{A} from the controller 600, and applies a display data signal for selecting a discharge cell to be displayed to the respective address electrodes.

The Y electrode driver 300 and the X electrode driver 400 receive a Y electrode driving signal S_{Y} and an X electrode driving signal S_{X} from the controller 600, and apply them to the Y and X electrodes.

The M electrode driver 500 receives an M electrode driving signal S_{M} from the controller 600, and applies it to the M electrodes. The M electrode driver 500 and the X electrode driver 400 may be arranged on the same printed circuit board to thus configure a more compact circuit.

In this instance, though not illustrated in FIG. 10, in the plasma display device, the M electrode driver 500 is coupled to the Y electrode driver 300 and the M electrode driver 500 is coupled to the X electrode driver 400. The Y electrode driver 300 and X electrode driver 400 receive an output of the M electrode driver and use the output to apply the sustain pulse voltage of Vs in the sustain period.

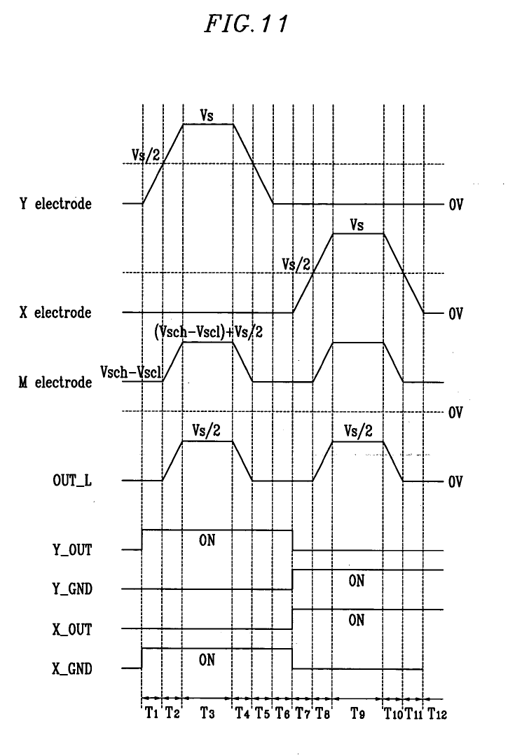

A method for using the output of the M electrode driver when the Y electrode driver and the X electrode driver apply the sustain pulse voltage of Vs in the sustain period will now be described in detail with reference to FIG. 11 to FIG. 16.

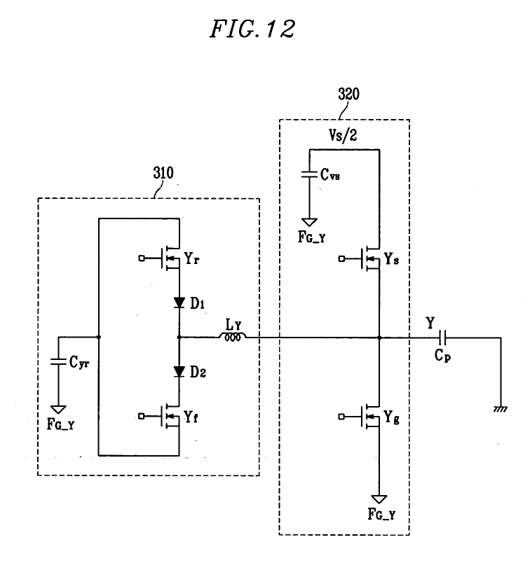

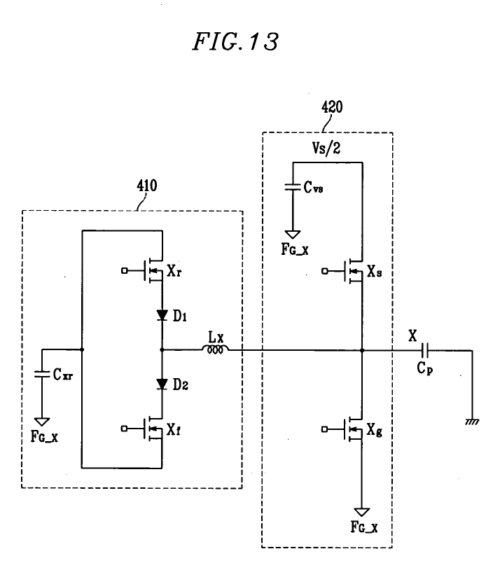

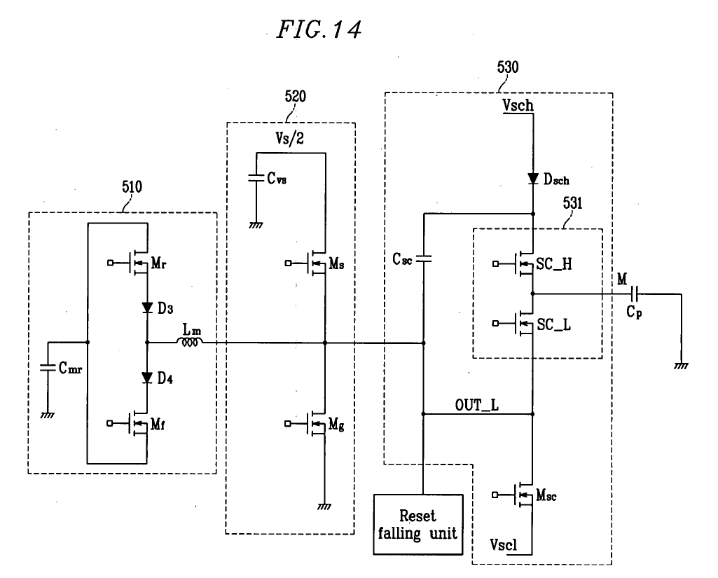

FIG. 11 shows a waveform applied in the sustain period and a switching operation in a driving waveform of a plasma display device according to a second exemplary embodiment of the present invention. FIG. 12, FIG. 13, and FIG. 14 show driving circuits of an X electrode driver, a Y electrode driver, and an M electrode driver for generating driving waveforms in the sustain period according to a second exemplary embodiment of the present invention.

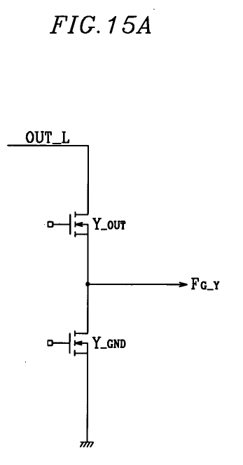

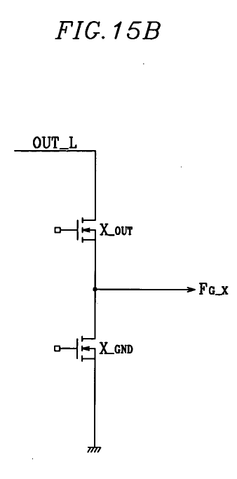

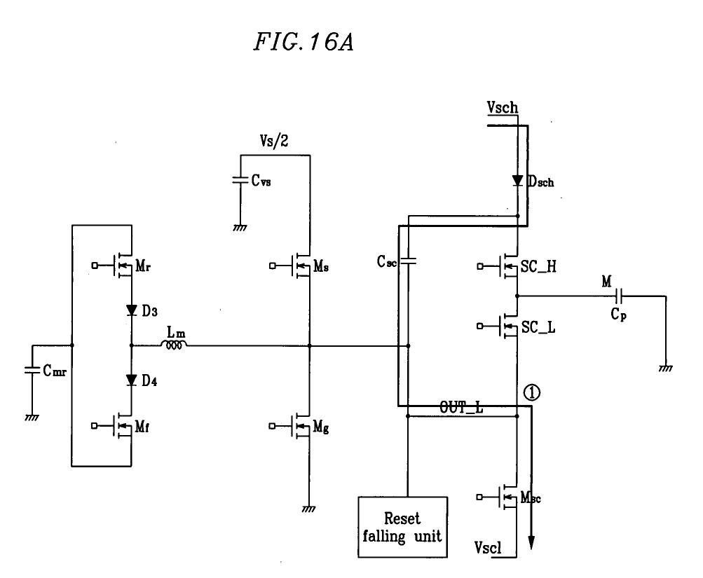

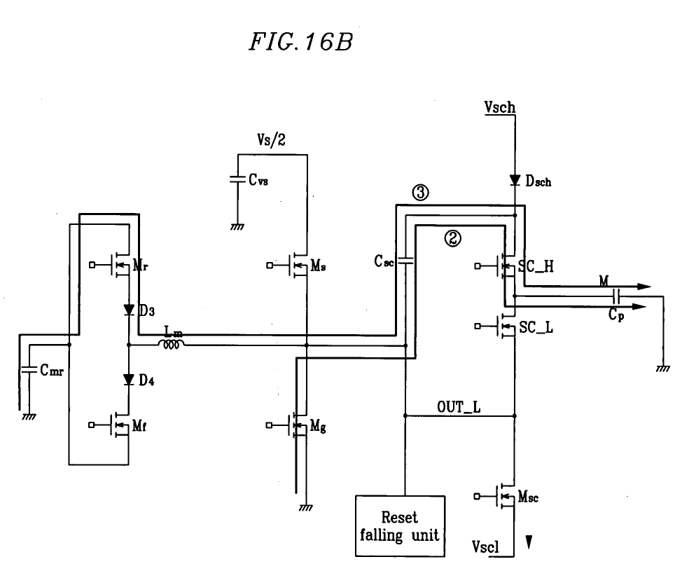

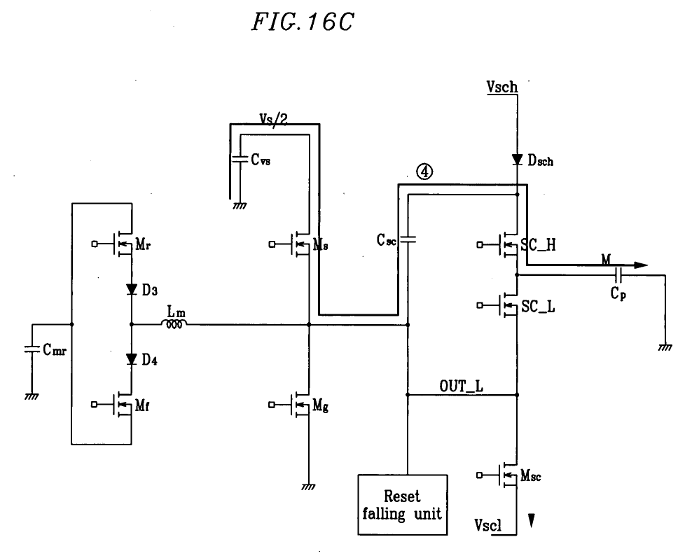

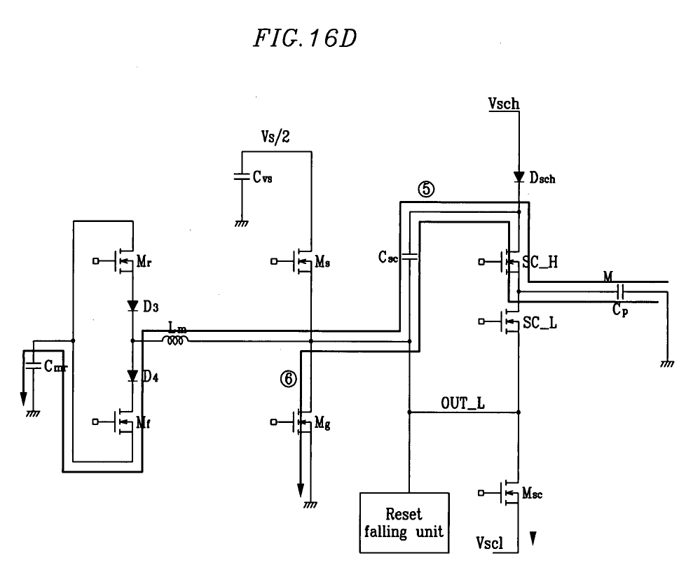

FIG. 15A shows a circuit for coupling a driving circuit of an M electrode driver and a driving circuit of a Y electrode driver, and FIG. 15B shows a circuit for coupling a driving circuit of an M electrode driver and a driving circuit of an X electrode driver. FIG. 16A to FIG. 16D show current paths for generating the driving waveforms shown in FIG. 11 in the driving circuit of the M electrode driver.

As shown in FIG. 12, the driving circuit of the Y electrode driver 300 includes a power recovery circuit 310 and a sustain discharge voltage supply 320. Switches shown in FIG. 12 are n-channel transistors, and the same may include field effect transistors (FET) with body diodes and other types of switches with the same or similar functions. A capacitance component formed by the address electrode A and the scan electrode Y, sustain electrode X, or M electrode, is illustrated to be a panel capacitor Cp in FIGS. 12, 13, and 14.

The power recovery circuit 310 includes switches Yr and Yf, an inductor Ly, diodes D1 and D2, and a capacitor Cyr. A drain of the switch Yr and a source of the switch Yf are coupled, and their node is coupled to a first terminal of a capacitor Cyr. The capacitor Cyr is charged with the voltage of Vs/4, and a second terminal of the capacitor Cyr is coupled to a floating ground FG_Y. The diodes D1 and D2 are coupled in series to the switches Yr and Yf. A node of the diode D1 and D2 is coupled to a first terminal of the inductor Ly, and a node of the switches Ys and Yg of the sustain discharge voltage supply 320 is coupled to a second terminal of the inductor Ly. The panel capacitor Cp is coupled in series to the second terminal of the inductor Ly, and the coupled point of the panel capacitor Cp corresponds to the Y electrode. The diodes D1 and D2 are provided in the opposite direction of the body diodes of the switches Yr and Yf so as to intercept current that may occur because of the body diodes of the switches Yr and Yf. In this instance, the diodes D1 and D2 may be eliminated when the switches Yr and Yf have no body diodes. The above-configured power recovery circuit 310 charges the panel capacitor Cp with the voltage of Vs/2 or discharges the same with 0 Volts.

The coupled order of the inductor Ly, the diode D1, and the switch Yr in the power recovery circuit 310 may be changed, and the coupled order of the inductor Ly, the diode D1, and the switch Yf may also be changed.

The sustain discharge voltage supply 320 coupled between the power recovery circuit 310 and the panel capacitor Cp includes two switches Ys and Yg. The switch Ys is coupled between a power source for supplying the voltage of Vs/2 and the second terminal of the inductor Ly, and the switch Yg is coupled between the second terminal of the inductor Ly and the floating ground FG_Y. In this instance, the power source supplying the voltage of Vs/2 includes a capacitor Cvs charged with the voltage of Vs/2, and a second terminal of the capacitor Cvs is coupled to the floating ground FG_Y. The switches Ys and Yg supply the voltages of Vs/2 and 0V to the panel capacitor Cp.

FIG. 13 shows a driving circuit of the X electrode driver 400 according to an embodiment of the present invention. As shown in FIG. 13, the driving circuit X electrode driver 400 for applying a driving waveform applied to the sustain electrode X in the sustain period corresponds to the above-described driving circuit of the Y electrode driver 300, and hence, no corresponding description thereof will be provided.

FIG. 14 shows a driving circuit of the M electrode driver 500 according to an embodiment of the present invention.

As shown in FIG. 14, the M electrode driver includes a power recovery circuit 510, a sustain period voltage supply 520, and an address period voltage supply 530. FIG. 14 shows a driving circuit for generating an M electrode waveform in the sustain period, which will be described. Driving circuits for generating waveforms applied in the reset period and the address period would be obvious to one skilled in the art and are therefore not described herein.

A selection circuit 531 is coupled to the M electrode as an IC format so that the M electrode driver may sequentially select the M electrodes in the address period, and voltages are applied to the M electrodes through the selection circuit 531. For ease of description, FIG. 14 shows a single M electrode and a single selection circuit 531, and a capacitance component formed at the electrodes (X, Y, and A electrodes) adjacent to the M electrode is illustrated to be a panel capacitor Cp. The electrodes (X, Y, and A electrodes) adjacent to the M electrode of the panel capacitor Cp are biased with the ground voltage.

The power recovery circuit 510 includes switches Mr and Mf an inductor Lm, diodes D3 and D4, and a capacitor Cmr. The capacitor Cmr is charged with the voltage of Vs/4. A node of a drain of the switch Mr and a source of the switch Mf is coupled to a first terminal of the power recovery capacitor Cmr, the ground voltage is coupled to a second terminal of the capacitor Cmr, and the switches Mr and Mf are coupled in series to the diodes D3 and D4. A first terminal of the inductor Lm is coupled to a node of the diodes D3 and D4, and a second terminal of the inductor Lm is coupled to a node of the switches Ms and Mg of the sustain period voltage supply 520. The second terminal of the inductor Lm is coupled in series to the panel capacitor Cp. The diode D3 establishes a rising path for increasing the voltage at the panel capacitor Cp when the switch Mr has a body diode. The diode D4 establishes a falling path for decreasing the voltage at the panel capacitor Cp when the switch Mf has a body diode. In this instance, the diodes D3 and D4 may be eliminated when the switches Mr and Mf have no body diodes. The above-configured power recovery circuit 510 charges or discharges the voltage at the panel capacitor Cp (i.e., the voltage at the M electrode).

The coupled order of the inductor Lm, the diode D3, and the switch Mr in the power recovery circuit 510 may be changed, and the coupled order of the inductor Lm, the diode D4, and the switch Mf may also be charged.

In this instance, the power recovery circuit 510 is provided to use LC resonance when the voltage at the node OUT_L is controlled to increase from the ground voltage of 0V to the voltage of Vs/2 or decrease from the voltage of Vs/2 to the ground voltage of 0V in the sustain period. The same power recovery circuit 510 may be eliminated when LC resonance is not used for supplying the voltage of Vs/2 and the ground voltage of 0V to the node OUT_L.

The sustain period voltage supply 520 coupled between the power recovery circuit 510 and the selection circuit 530 includes switches Ms and Mg. The switch Ms is coupled between the power source for supplying the voltage of Vs/2 and the second terminal of the inductor Lm, and the switch Mg is coupled between the second terminal of the inductor and the power source for supplying the ground voltage. The power source supplying the voltage of Vs/2 includes a capacitor Cvs charged with the voltage of Vs/2, and a second terminal of the capacitor Cvs is coupled to ground. The sustain period voltage supply 520 provides the voltage of Vs/2 or the ground voltage of 0V to the node OUT_L in the sustain period.

The selection circuit 531 of the address period voltage supply 530 includes switches SC_H and SC_L which may have a body diode with an anode coupled to a source and a cathode coupled to a drain, respectfully. A source of the switch SC_H and a drain of the switch SC_L are coupled to the M electrode of the panel capacitor Cp, and a source of the switch SC_L is coupled to the node OUT_L.

A reset falling unit is coupled to the node OUT_L, and the switch Msc is coupled between the node OUT_L and the power source Vscl for supplying a scan voltage of Vscl. The reset falling unit represents a circuit for generating a reset waveform which gradually decreases in the falling period of the reset period. The switch Msc supplies the scan voltage of Vscl to the M electrode in the address period, and remains in the turned-on state in the address period. The scan voltage of Vscl is applied to the M electrode when the switch SC_L is turned on while the switch Msc is turned on.

The capacitor Csc of the address period voltage supply 530 is coupled between a drain of the switch SC_H and the node OUT_L of the selection circuit 531. The power source Vsch for supplying the voltage of Vsch is coupled to the capacitor Csc through the diode Dsch. The capacitor Csc is charged with the voltage Vsch−Vscl by power sources Vsch and Vscl when the switch Msc is turned on. An anode of the capacitor Csc charged with the voltage of Vsch−Vscl is coupled to a drain of the switch SC_H and a cathode of the capacitor is coupled to the node OUT_L. Because the switch Msc is on in the address period, the capacitor Csc is charged with the voltage of Vsch−Vscl.

FIG. 15A shows a circuit coupled between the node OUT_L of the M electrode driver 500 driving circuit and the floating ground FG_Y of the Y electrode driver 300 driving circuit. FIG. 15B shows a circuit coupled between the node OUT_L of the M electrode driver 500 driving circuit and the floating ground FG_X of the X electrode driver 400 driving circuit Nodes OUT_L shown in FIG. 15A and FIG. 15B correspond to the node OUT_L shown in FIG. 14, the floating ground FG_Y shown in FIG. 15A corresponds to the floating ground FG_Y shown in FIG. 12, and the floating ground FG_X shown in FIG. 15B corresponds to the floating ground FG_X shown in FIG. 13.

In FIG. 15A, an output of OUT_L is provided to the floating ground FG_Y of the driving circuit of the Y electrode driver 300 when the switch Y_OUT is turned on and the switch Y_GND is turned off, and the ground voltage of 0V is provided to the floating ground FG_Y of the driving circuit of the Y electrode driver 300 when the switch Y_OUT is turned off and the switch Y_GND is turned on. In FIG. 15B, an output of OUT_L is provided to the floating ground FG_X of the driving circuit of the X electrode driver 400 when the switch X_OUT is turned on and the switch X_GND is turned off, and the ground voltage of 0V is provided to the floating ground FG_X of the driving circuit of the X electrode driver 400 when the switch X_OUT is turned off and the switch X_GND is turned on.

A method for generating the driving waveform in the sustain period according to a second embodiment of the present invention shown in FIG. 11 in the driving circuit of the above-configured driver will now be described.

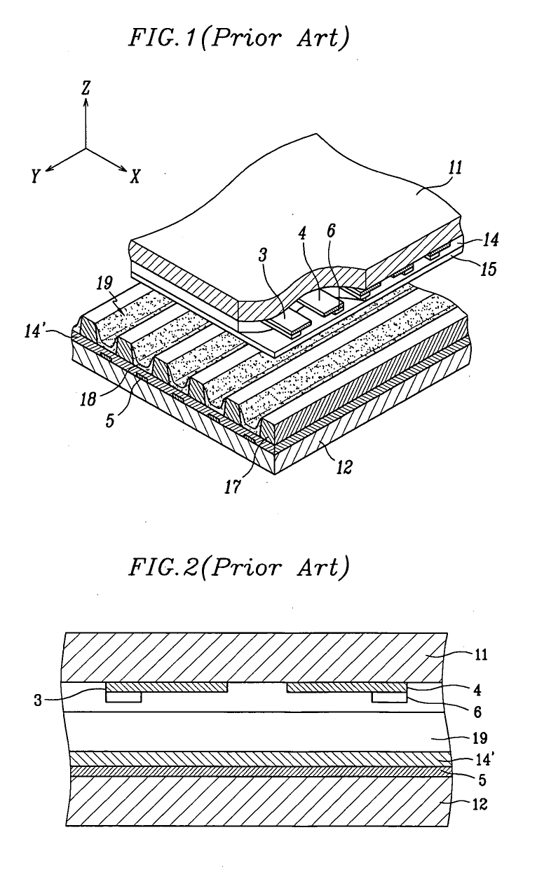

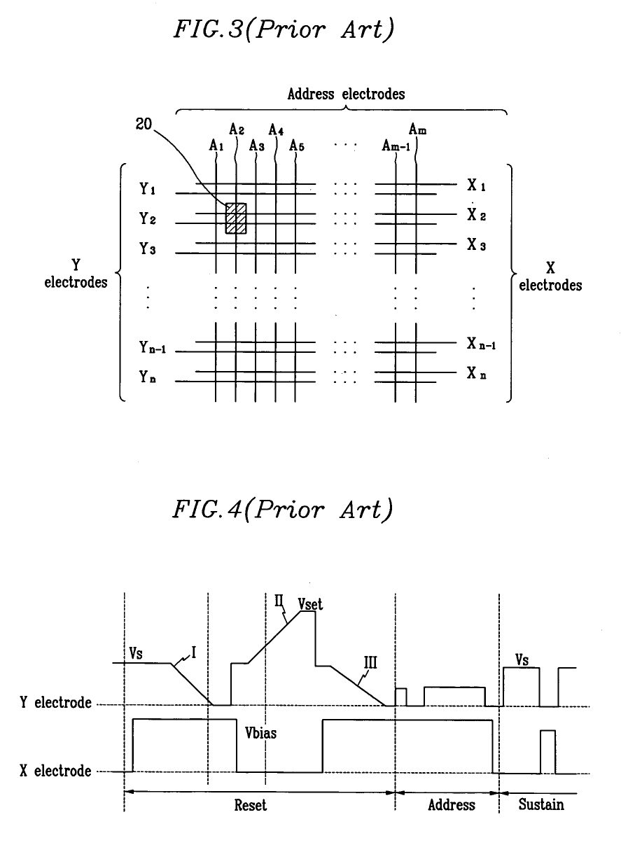

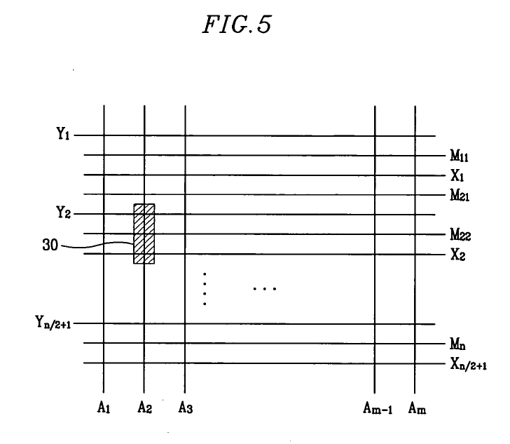

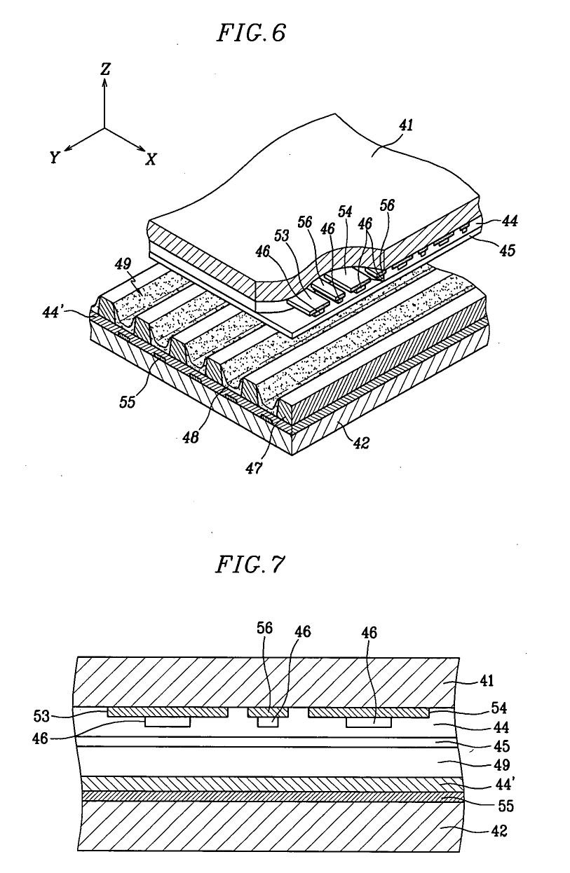

Referring to FIG. 1, the switch Y_OUT is turned on and the switch X_GND is turned on in the periods from T_{1 to T}₆, and the switch Y_GND is turned on and the switch X_OUT is turned on in the periods from T₇ to T₁₂. Therefore, the voltage at the node OUT_L of the M electrode driver is provided to the floating ground FG_Y of the Y electrode driver and the ground voltage of 0V is output to the floating ground FG_X of the X electrode driver in the periods from T₁ to T₆, and the voltage at the node OUT_L of the M electrode driver is provided to the floating ground FG_X of the X electrode driver and the ground voltage of 0V is output to the floating ground FG_Y of the Y electrode driver in the periods from T₇ to T₁₂.

In the address period, the switch Msc maintains the turned-on state as described above so that the current path (\textcircled{1}) is formed in the order of the power source Vsch, the capacitor Csc, the switch Msc, and the power source Vscl as shown in FIG. 16A, and the capacitor Csc is charged with voltage Vsch−Vscl.

In this instance, the switches Mg, SC_H, and Yr are turned on at the start of T₁ of the sustain period. When the switches Mg and SC_H are turned on, the current path (\textcircled{2}) is formed in the order of the ground power source, the switch Mg, the capacitor Csc, the switch SC_H, and the panel capacitor Cp as shown in FIG. 16B, and since the capacitor Csc is charged with the voltage of Vsch−Vscl and the voltage at the cathode of the capacitor Csc is changed to the ground voltage of 0V, the voltage at the anode thereof is changed to the voltage of Vsch−Vscl. Therefore, the voltage of Vsch−Vscl is applied to the M electrode, and the ground voltage of 0V is applied to the node OUT_L. When the ground voltage of 0V at the node OUT_L is applied to the floating ground FG_Y of the Y electrode driver and the switch Yr is turned on, LC resonance occurs on the path of the capacitor Cyr, the switch Yr, the diode D1, the inductor Ly, and the Y electrode so that the voltage at the Y electrode rises from the ground voltage of 0V to the voltage of Vs/2.

The switches Mr, SC_H, and Ys are turned on at T₂. When the switches Mr and SC_H are turned on, the current path (\textcircled{3}) in the order of the capacitor Cmr, the switch Mr, the diode D3, the inductor Lm, the capacitor Csc, the switch SC_H, and the panel capacitor Cp is formed as shown in FIG. 16B, and the voltage at the M electrode voltage rises from the voltage of Vsch−Vscl to the voltage of (Vsch−Vscl)+Vs/2. The voltage at the node OUT_L is increased from the ground voltage of 0V to the voltage of Vs/2, and the increased voltage at the node OUT_L is applied to the floating ground FG_Y of the Y electrode driver. In this instance, the voltage at the second terminal of the capacitor Cvs is increased from 0V to the voltage of Vs/2 and the voltage at the first terminal of the capacitor is increased from the voltage of Vs/2 to the voltage of Vs since the switch Ys is turned on and the floating ground FG_Y increases. Therefore, the voltage applied to the Y electrode rises from Vs/2 to Vs.

The switches Ms, SC_H, and Ys are turned on at T₃. When the switches Ms and SC_H are turned on, the voltage of (Vsch−Vscl)+Vs/2 is applied to the M electrode and the voltage of Vs/2 is applied to the node OUT_L as shown in FIG. 16C because of the current path (\textcircled{4}) in the order of the power source Vs/2, the switch Ms, the capacitor Csc, the switch SC_H, and the panel capacitor Cp. The voltage at the Y electrode is maintained at the increased voltage of Vs since the switch Ys is turned on.

The switches Mf, SC_H, and Ys are turned on at T₄. When the switches Mf and SC_H are turned on, the current path (\textcircled{5}) in the order of the panel capacitor Cp, the switch SC_H, the capacitor Csc, the inductor Lm, the diode D4, the switch Mf, and the capacitor Cmr is formed as shown in FIG. 16D, and the voltage at the M electrode is decreased from the voltage of (Vsch−Vscl)+Vs/2 voltage to the voltage of Vsch−Vscl. The voltage at the node OUT_L is decreased from the voltage of Vs/2 to the voltage of 0V because of the current path (\textcircled{5}), and the decreased voltage at the node OUT_L is applied to the floating ground FG_Y of the Y electrode driver. Thus, the voltage at the second terminal of the capacitor Cvs is decreased from the voltage of Vs/2 to the voltage of 0V and the first terminal of the capacitor is decreased from the voltage of Vs to the voltage of Vs/2 when the switch Ys is turned on and the floating ground FG_Y is increased. Therefore, the voltage rising from the voltage of Vs to the voltage of Vs/2 is applied to the Y electrode.

The switches Mg, SC_H, and Yf are turned on at T₅ of the sustain period. When the switches Mg and SC_H are turned on, the current path (\textcircled{6}) in the order of panel capacitor (Cp), the switch SC_H, the capacitor Csc, the switch Mg, and the ground power source is formed as shown in FIG. 16D, and the voltage of Vsch−Vscl is applied to the M electrode. The ground voltage of 0V is applied to the node OUT_L, and the ground voltage of 0V is applied to the floating ground FG_Y of the Y electrode driver. In this instance, when the switch Yf is turned on, an LC resonance current path in the order of the panel capacitor Cp, the inductor Ly, the diode D2, the switch Yf, and the capacitor Cyr is formed, and the voltage at the Y electrode is decreased from the voltage of Vs/2 to the ground voltage of 0V.

The switches Mg, SC_H, and Yg are turned on at T₆. When the switches Mg and SC_H are turned on, the voltage at the M electrode is maintained at the voltage of Vsch−Vscl, and the voltage at the node OUT_L is maintained at the ground voltage of 0V. When the switch Yg is turned on, the ground voltage of 0V is applied to the Y electrode.

In the periods from T_{1 to T}₆, the switch Xg shown in FIG. 13 and the switch X_GND shown in FIG. 15B are turned on. When the switch X_GND is turned on, the ground voltage of 0V is output to the floating ground FG_X of the X electrode driver. The ground voltage of 0V is output to the floating ground FG_X of the X electrode driver and the switch Xg is turned on, and hence, the ground voltage of 0V is applied to the X electrode.

In the respective periods from T₇ to T₁₂, the operations described for the Y electrode and M electrode, with respect to the periods from T₁ to T₆, are applied to the switches for the X electrode and the M electrode. Hence, no corresponding descriptions will be provided. In addition, in the periods from T₇ to T₁₂, the switches Y_GND and Yg are turned on, and the ground voltage of 0V is applied to the scan electrode Y.

As shown in FIG. 11, the effect of applying the voltage of Vm is achieved in a like manner of the first embodiment since the voltages of Vsch−Vscl and (Vsch−Vscl)+Vs/2 are applied to the M electrode in the driving waveform of the sustain period according to the second embodiment of the present invention.

The voltage of the power source is given to be Vs/2 in the M electrode driver of FIG. 14. However, voltages lower than the voltage of Vs may be used to generate the same effect as that of the embodiments of the present invention.

As shown in FIG. 8 and FIG. 1, the displacement current flows when the sustain pulse of the Y or X electrode is increased from the ground voltage of 0V to the voltage of Vs/2 and when the voltage at the M electrode is increased from the voltage of Vsch−Vscl to the voltage of (Vsch−Vscl)+Vs/2. As compared to the conventional method, where Vs was applied to the X and Y electrodes, half the displacement current flows under half the voltage load. As a result, the thermal loss caused by the higher current is thereby reduced. The thermal loss of RI² is generated when the current of I flows in the conventional case. Since the embodiment of this invention uses the current of ½*I, the thermal loss is one-half of the thermal loss in the conventional method of driving.

In addition, the scan electrode driver and the sustain electrode driver each use the voltage Vs/2 to generate the voltage of Vs in the sustain period, thereby reducing the voltage of switches and production costs of circuits.

Recently, the pressure of Xenon has been increased to improve discharge efficiency, and when highly pressurized Xe is used, the voltage of Vs of the sustain pulse is increased, and the increase of voltage generates a load to the circuits of a Switching-mode power supply. Accordingly, the use of drivers embodied in the present invention reduces loads on circuits caused by the increase of the sustain pulse voltage.

As described, poor discharges are prevented by forming a middle electrode between the X electrode and a Y electrode, applying a reset waveform and a scan waveform to the middle electrode, and applying a sustain discharge voltage waveform to the X electrode and the Y electrode. Further, the voltage of the power source used for the driver for applying the sustain pulse may be reduced by using the voltage output by the middle electrode driver to achieve the desired sustain pulse voltage. Therefore, the displacement current can be substantially reduced to half, and the thermal loss caused by the parasitic component on the current path may be reduced. In addition, the expense of manufacturing circuits may decrease since the withstanding voltage of the driver for applying the sustain pulse is also reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display device, comprising:
a plasma display panel comprising:
a first electrode;
a second electrode; and
a third electrode in parallel with the first electrode and the second electrode; and
a first driving circuit for driving the first electrode;
a second driving circuit for driving the second electrode; and
a third driving circuit for driving the third electrode,
wherein the first driving circuit comprises:
a first switch coupled to an output terminal of a first power source for supplying a voltage to the first electrodes in a sustain period, and coupled between a first terminal of a first capacitor charged with a first voltage and the first electrode; and
a second switch coupled between a second power source for supplying a second voltage that is less than the first voltage to the first electrode in the sustain period and the first electrode; and
wherein the third driving circuit comprises:
a third switch having a first terminal coupled to the third electrode; a fourth switch coupled between a third power source for supplying a third voltage that is greater than the second voltage to a second terminal of the third switch in the sustain period and the second terminal of the third switch;
a fifth switch coupled between a fourth power source for supplying a fourth voltage that is less than the first voltage to the second terminal of the third switch in the sustain period and the second terminal of the third switch; and
a sixth switch coupled between the second terminal of the third switch and the second terminal of the first capacitor, and supplying an output of the second terminal of the third switch to the second terminal of the first capacitor in the sustain period.

2. The plasma display device of claim 1, wherein the first voltage is less than the sustain pulse voltage applied to the first electrode or the second electrode in the sustain period.

3. The plasma display device of claim 2, wherein the fourth switch and the sixth switch are turned on while the first switch is turned on, and the sustain pulse voltage is applied to the first electrode.

4. The plasma display device of claim 1, wherein the third switch performs a switching operation to apply a scan pulse voltage to the third electrode in an address period.

5. The plasma display device of claim 4, wherein the third driving circuit further comprises:
a seventh switch, wherein the seventh switch has a first terminal coupled to the third electrode, and performs a switching operation to apply a voltage that is greater than the scan pulse voltage to the third electrode in an address period; and
a second capacitor coupled between a second terminal of the seventh switch and the second terminal of the third switch.

6. The plasma display device of claim 5, wherein a predetermined voltage is charged in the second capacitor before the sustain period and said predetermined voltage is applied to the third electrode during the sustain period.

7. The plasma display device of claim 1, further comprising:
an eighth switch coupled between the sixth switch and the fourth power source, and turned on while a sustain pulse is applied to the second electrode.

8. The plasma display device of claim 1, wherein the first voltage and the third voltage are substantially equal, and the second voltage and the fourth voltage are substantially equal.

9. The plasma display device of claim 1, wherein the third driving circuit further comprises:
an inductor having a first terminal coupled to the second terminal of the third switch;
a fifth power source for supplying a resonance voltage to the second terminal of the third switch;
a ninth switch coupled between the fifth power source and a second terminal of the inductor; and
a tenth switch coupled between the fifth power source and the second terminal of the inductor.

10. The plasma display device of claim 1, wherein the third electrode is provided between the first electrode and the second electrode, a reset waveform is applied to the third electrode in a reset period, and a scan pulse voltage is applied to the third electrode in an address period.

11. A method for driving a plasma display device; said plasma display device comprising:
a plurality of first electrodes;
a plurality of second electrodes;
a plurality of third electrodes provided parallel to the first electrodes and the second electrodes; and
a first driving circuit, a second driving circuit, and a third driving circuit for respectively driving the first electrodes, the second electrodes, and the third electrodes;
wherein the first driving circuit comprising a first switch coupled to an output terminal of a first power source for supplying a voltage to the first electrodes, and coupled between a first terminal of a first capacitor charged with a first voltage and the first electrode; the third driving circuit comprising a second switch having a first terminal coupled to the third electrode and performing a switching operation for applying a scan pulse voltage to the third electrode in an address period; and the plasma display device comprising a third switch coupled between a second terminal of the first capacitor and a second terminal of the second switch,
said method for driving said plasma display device comprising:
in a sustain period, increasing a voltage at the first electrode to the first voltage by using the first driving circuit; increasing a voltage at the second terminal of the second switch to a second voltage by using the third driving circuit, and increasing the voltage at the first electrode to the third voltage from the first voltage by turning on the third switch;
maintaining the voltage at the first electrode to be the third voltage;
decreasing a voltage at the second terminal of the second switch to a fourth voltage that is less than the second voltage by using the third driving circuit, and decreasing a voltage at the first electrode to the first voltage from the third voltage by turning on the third switch; and
decreasing the voltage at the first electrode to a fifth voltage that is less than the first voltage by using the first driving circuit.

12. The method of claim 11, wherein the first voltage is equivalent to the third voltage minus the second voltage.

13. The method of claim 11, wherein the third driving circuit further comprises:
a fourth switch coupled between a second power source for supplying the second voltage and the second terminal of the second switch; and
a fifth switch coupled between a third power source for supplying the fourth voltage and the second terminal of the second switch, and
wherein said increasing a voltage at the second terminal of the second switch to a second voltage by using the third driving circuit comprises turning on the fourth switch, and said decreasing a voltage at the second terminal of the second switch to a fourth voltage that is less than the second voltage by using the third driving circuit comprises turning on the fifth switch.

14. The method of claim 11, wherein the fourth voltage and the fifth voltage are substantially equivalent.

15. A method for driving a plasma display device, said plasma display device comprising:
a first driving circuit for supplying a first sustain voltage to a first electrode;
wherein the first driving circuit comprises a first capacitor charged with a first voltage, and a first switch coupled between a first terminal of the first capacitor and the first electrode;
said method for driving a plasma display device comprising:
in a sustain period, increasing the voltage at the first electrode to the first voltage by using the first driving circuit during a first period; increasing a voltage at a second terminal of the first capacitor by using a first power source unit, and increasing the voltage at the first electrode to the first sustain voltage during a second period;
maintaining the voltage at the first electrode at the first sustain voltage during a third period;
decreasing the voltage at the second terminal of the first capacitor by using the first power source unit, and decreasing the voltage at the first electrode to the first voltage during a fourth period; and
decreasing the voltage at the first electrode to a second voltage that is less than the first voltage by using the first driving circuit during a fifth period.

16. The method of claim 15, wherein the first power source unit supplies a third voltage that corresponds to a difference between the first sustain voltage and the first voltage, and said method further comprising:
supplying the third voltage from the first power source to the second terminal of the first capacitor.

17. The method of claim 16, said method further comprising:
supplying the third voltage from the first power source to the second terminal of the first capacitor during the second, third and fourth periods; and
supplying the second voltage to the second terminal of the first capacitor during the first and fifth periods.

18. The method of claim 15, said plasma display device further comprises:
a second driving circuit for supplying a second sustain voltage to a second electrode;
said method further comprising:
supplying the second voltage to the second electrode during the first period to the fifth period.

19. The method of claim 18, said plasma display device further comprises:
a third driving circuit for driving a third electrode provided parallel to the first electrode and the second electrode;
wherein the voltage supplied by the first power source unit is supplied according to the third driving circuit.

20. The method of claim 19, further comprising:
applying a reset waveform to the third electrode by the third driving circuit in a reset period, and
applying a scan pulse voltage to the third electrode by the third driving circuit in an address period.
